(19) United States
(12) Patent Application Publication
(10) Pub. No.: US 2017/0085624 A1
(43) Pub. Date: Mar. 23, 2017

(54) METHODS AND SYSTEMS FOR TRANSMITTING INFORMATION GENERATED FOR EVENTS

(71) Applicant: XEROX CORPORATION, Norwalk, CT (US)

(72) Inventors: Tridib Mukherjee, Bangalore (IN); Amit Kumar, Jind (IN); Deepthi Chander, Cochin (IN); Koustuv Dasgupta, Bangalore (IN); Anirban Mondal, Bangalore (IN)

(21) Appl. No.: 14/857,855

(22) Filed: Sep. 18, 2015

(51) Int. Cl. H04L 29/08; H04L 12/26

(52) U.S. Cl. CPC H04L 67/10; H04L 43/0876

(57) ABSTRACT

The disclosed embodiments illustrate methods and systems for transmitting information generated for one or more events. The method includes receiving queries from subscribers. The method includes receiving said information pertaining to said one or more events from sensors. Thereafter, the method includes transmitting said information pertaining to said one or more events to said subscribers based on a first boundary condition and a second boundary condition. The information pertaining to said one or more events is transmitted using a first technique when at least a number of events in said one or more events satisfy said first boundary condition. Further, the information pertaining to said one or more events is transmitted using a second technique when at least said number of events in said one or more events satisfy said second boundary condition. The method is performed by said one or more microprocessors in a notification distribution server.

### TECHNICAL FIELD

The presently disclosed embodiments are related, in general, to a cloud-computing network. More particularly, the presently disclosed embodiments are related to methods and systems for transmitting information generated for one or more events in the cloud-computing network.

### BACKGROUND

Cloud-based sensing refers to a sensing technique in which data acquired by one or more sensors may be hosted over the cloud. Further, such data may be utilized to report events or to inform the concerned authorities. For example, in smart cities, the data captured by the one or more sensors may be transmitted to concerned authorities, who may act upon the received data to identify an anomaly. Based on the identified anomaly, the concerned authorities may plan appropriate actions. Citizens of the smart cities may also subscribe for receiving information pertaining to the events. For example, the citizens may subscribe to receive periodic reports on traffic situations on certain roads in the city.

Generally, the data acquired from the one or more sensors are handled by an application server in the cloud network. With increasing number of received events (or data from the one or more sensors) and number of subscribers (e.g., authorities and citizens), the applications server (handling the data) may not be able to handle such load, and thus may not be able to send reports in real time to the subscribers.

### SUMMARY

According to embodiments illustrated herein, there is provided a method for transmitting information generated for one or more events. The method includes receiving, by a transceiver, one or more queries from one or more subscribers. The method further includes receiving, by the transceiver, the information pertaining to the one or more events from one or more sensors. The method further includes transmitting the information pertaining to the one or more events to the one or more subscribers based on a first boundary condition and a second boundary condition. The information pertaining to the one or more events is transmitted using a first technique when at least a number of events in the one or more events satisfy the first boundary condition. Further, the information pertaining to the one or more events is transmitted using a second technique when at least the number of events in the one or more events satisfy the second boundary condition. The method is performed by one or more microprocessors in a notification distribution server.

According to embodiments illustrated herein, there is provided a system for transmitting information generated for one or more events. The system includes a transceiver, in a notification distribution server, operable to receive one or more queries from one or more subscribers. The system further includes the transceiver, in the notification distribution server, operable to receive information pertaining to the one or more events from one or more sensors. The system includes one or more microprocessors, in the notification distribution server, operable to transmit the information pertaining to the one or more events to the one or more subscribers based on a first boundary condition and a second boundary condition. The information pertaining to the one or more events is transmitted using a first technique when at least a number of events in the one or more events satisfy the first boundary condition. Further, the information pertaining to the one or more events is transmitted using a second technique when at least the number of events in the one or more events satisfy the second boundary condition.

According to embodiments illustrated herein, there is provided a computer program product for use with a computer. The computer program product includes a non-transitory computer readable medium. The non-transitory computer readable medium stores a computer program code for transmitting information generated for one or more events. The computer program code is executable by a transceiver, in a notification distribution server, to receive one or more queries from one or more subscribers. The computer program code is further executable by the transceiver, in the notification distribution server, to receive the information pertaining to the one or more events from one or more sensors. The computer program code is further executable by one or more microprocessors, in the notification distribution server, to transmit the information pertaining to the one or more events to the one or more subscribers based on a first boundary condition and a second boundary condition. The information pertaining to the one or more events is transmitted using a first technique when at least a number of events in the one or more events satisfy the first boundary condition. Further, the information pertaining to the one or more events is transmitted using a second technique when at least the number of events in the one or more events satisfy the second boundary condition.

### BRIEF DESCRIPTION OF DRAWINGS

The accompanying drawings illustrate various embodiments of systems, methods, and other aspects of the disclosure. Any person with ordinary skill in the art will appreciate that the illustrated element boundaries (e.g., boxes, groups of boxes, or other shapes) in the figures represent one example of the boundaries. It may be that in some examples, one element may be designed as multiple elements or that multiple elements may be designed as one element. In some examples, an element shown as an internal component of one element may be implemented as an external component in another, and vice versa. Furthermore, elements may not be drawn to scale.

Various embodiments will hereinafter be described in accordance with the appended drawings, which are provided to illustrate, and not to limit the scope in any manner, wherein like designations denote similar elements, and in which:

FIG. 1 is a block diagram illustrating a system environment in which various embodiments may be implemented;

FIG. 2 is a block diagram of an event generation server, in accordance with at least one embodiment;

FIG. 3 is a flowchart illustrating a method for generation one or more events, in accordance with at least one embodiment;

FIG. 4 is a flowchart illustrating a method for detecting the one or more events based on an event configuration file, in accordance with at least one embodiment;

FIG. 5 is a block diagram of a notification distribution server, in accordance with at least one embodiment;

FIG. 6 is a flowchart illustrating a method for transmitting the information for the one or more events, in accordance with at least one embodiment;

FIG. 7 is a flowchart illustrating a method for determining a first boundary condition and a second boundary condition, in accordance with at least one embodiment; and

FIG. 8 is a graphical representation illustrating a first boundary condition and a second boundary condition, in accordance with at least one embodiment.

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternate and suitable approaches to implement the functionality of any detail described herein. Therefore, any approach may extend beyond the particular implementation choices in the following embodiments described and shown.

References to “one embodiment”, “an embodiment”, “at least one embodiment”, “one example”, “an example”, “for example” and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Definitions: The following terms shall have, for the purposes of this application, the respective meanings set forth below.

A “computing device” refers to a device that includes a processor/microcontroller and/or any other electronic component, a device, or a system that performs one or more operations according to one or more programming instructions. Examples of the computing device include, but are not limited to, a desktop computer, a laptop, a PDA, a mobile phone, a smart-phone, a tablet computer, and the like. In an embodiment, the one or more computing devices may correspond to one or more subscribers.

An “event” refers to an activity that occurs at a predetermined time at a predetermined location and may or may not involve one or more individuals. In an embodiment, the event may correspond to an anomaly detected by one or more sensors at a remote location. Examples of various types of events may include, but are not limited to, a seasonal event, a personal event, a public event, a business event, or a sports event.

“Information pertaining to the one or more events” refers to a measure of physical quantity measured by one or more sensors at a predetermined time at a predetermined location.

“One or more subscribers” refer to one or more users or customers who may have subscribed to information pertaining to one or more events. In an embodiment, the one or more subscribers may transmit one or more queries to a notification distribution server. The one or more subscribers may receive information in response to the one or more queries.

“One or more queries” may correspond to one or more codes that a computer can understand and may be used to retrieve information, which may be of interest to one or more subscribers. In an embodiment, the one or more queries may correspond to at least one of primitive queries, abstract queries, and subscription requests for the information retrieval. In an embodiment, the primitive queries may further comprise one or more event queries, one or more spatial queries, and one or more temporal queries.

A “sensor” refers to a transducer that is used to measure a physical quantity. For example, a sensor may be used to measure water level in overhead water tanks. In an embodiment, the sensor may convert one form of energy to another form of energy. In an embodiment, the sensor may be used to detect/measure events or anomaly. Further, the sensor may provide the measurement as an electrical or optical signal.

A “boundary condition” refers to a condition that may be utilized to determine a technique based on which the information pertaining to the one or more events is transmitted to subscribers. In an embodiment, the information pertaining to the one or more events may be transmitted based on a first technique or a second technique.

A “resource utilization” refers to a utilization of one or more computational resources of a notification distribution server. In an embodiment, the one or more computational resources may include, but are not limited to a CPU, a memory unit, a network, or an input/output device. In an embodiment, the notification distribution server may utilize the one or more computational resources to transmit the information pertaining to the one or more events to the one or more subscribers.

A “performance parameter” refers to a measure of performance of an application server or a notification distribution server. In an embodiment, the performance parameter may be directly proportional to successful distributions of the notifications pertaining to the one or more events. In an embodiment, the performance parameter is determined based on a percentage of successful transmission of information pertaining to the one or more events or a delay in transmission of the information pertaining to the one or more events from the rate of reception of the one or more events. In an embodiment, the performance parameter may be utilizable to benchmark the notification distribution server. In an embodiment, the performance parameter may be utilized to determine a first boundary condition and a second boundary condition pertaining to the transmission of the notifications.

A “time period” refers to a time duration after which the notifications or the information pertaining to the one or more events may be transmitted to the one or more subscribers.

An “event-triggered notification technique” refers to a technique that may be utilized to transmit information to the one or more subscribers as soon as the one or more events are generated or detected by the one or more sensors.

A “time-triggered notification technique” refers to a technique that may be utilized to transmit information pertaining to the one or more events to the one or more subscribers after a pre-defined time duration elapses.

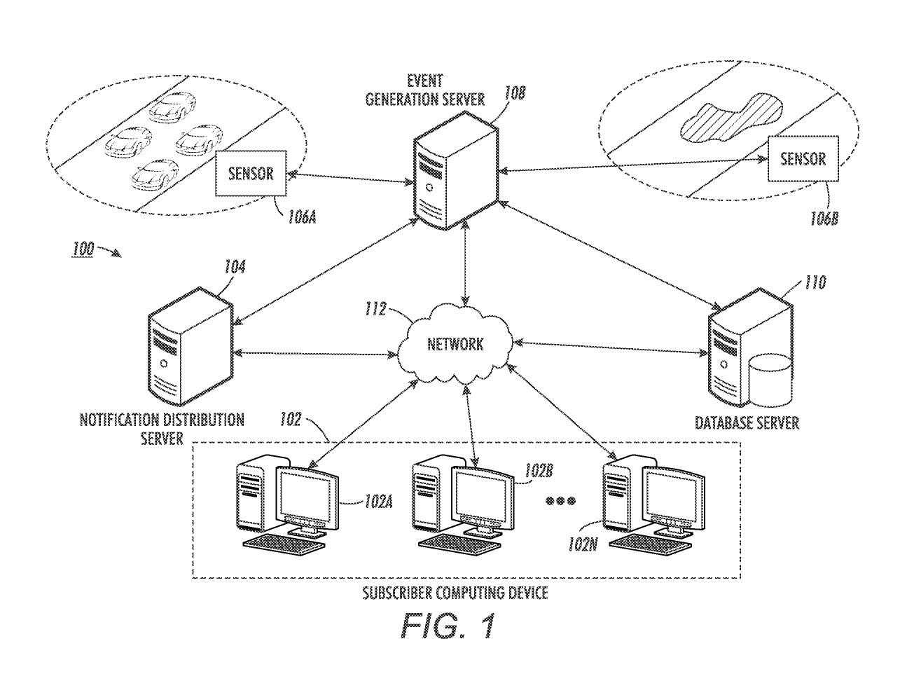

FIG. 1 is a block diagram illustrating a system environment 100 in which various embodiments can be implemented. The system environment 100 includes one or more subscriber computing devices 102a, 102b . . . 102n (hereinafter referred to as a subscriber computing device 102), a notification distribution server 104, one or more sensors 106, an event generation server 108, a database server 110, and a network 112. Various devices in the system environment 100 (e.g. the subscriber computing device 102, the notification distribution server 104, the event generation server 108, and the database server 110) may be interconnected over the network 112.

The subscriber computing device 102 refers to a computing device used by a subscriber. In an embodiment, using the subscriber computing device 102, the subscriber may subscribe to information/notification pertaining to one or more events that may occur in an area of interest for the subscriber. In an embodiment, the subscriber may utilize the subscriber computing device 102 to transmit one or more queries to the notification distribution server 104. The one or more queries may correspond to at least one of subscriptions for the information pertaining to the one or more events, event queries, spatial queries, or temporal queries. The subscriber computing device 102 may receive the information pertaining to the one or more events from the notification distribution server 104, in response to the one or more transmitted queries. In an embodiment, the subscriber computing device 102 may correspond to various types of computing devices, such as, but not limited to, a desktop computer, a laptop, a PDA, a mobile device, a smartphone, a tablet computer (e.g., iPad® and Samsung Galaxy Tab®), and the like.

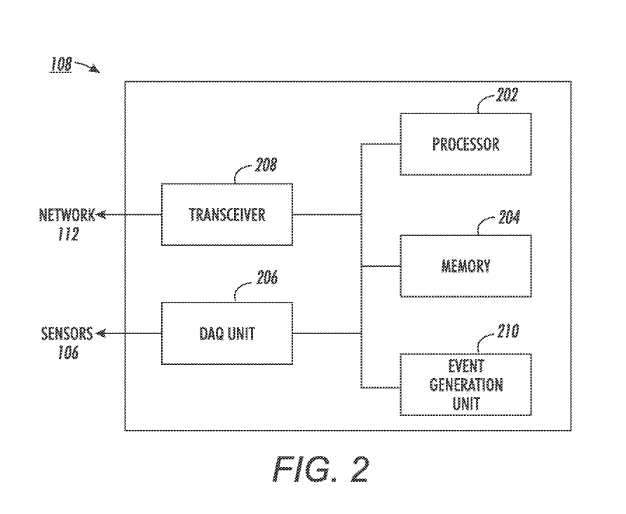

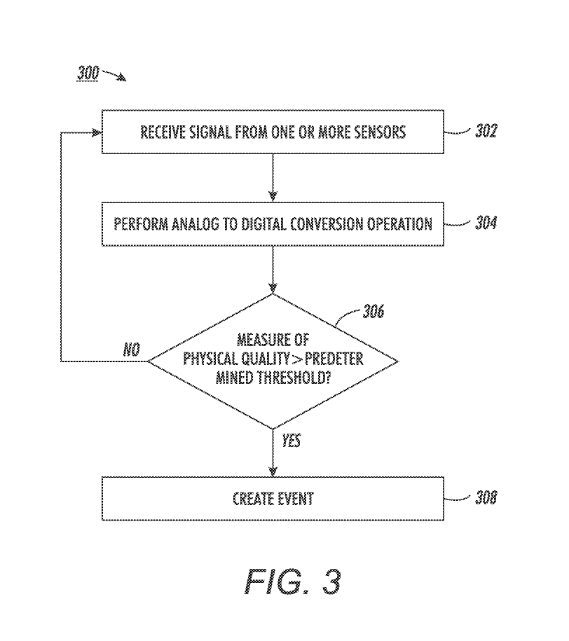

The notification distribution server 104 may refer to a computing device or a software framework that may provide a generalized approach to create the notification distribution server implementation. In an embodiment, the function of the notification distribution server 104 may be dedicated to the efficient execution of procedures, such as, but not limited to, programs, routines, or scripts stored in one or more memories for supporting its applied applications. In an embodiment, the notification distribution server 104 may receive the one or more queries from the subscriber computing device 102. Further, the notification distribution server 104 may retrieve the information pertaining to the one or more events from the database server 110. Thereafter, the notification distribution server 104 may determine whether a number of events, from the one or more events, satisfies a first boundary condition or a second boundary condition. Based on the determination, the notification distribution server 104 may transmit the information pertaining to the one or more events to the subscriber computing device 102, either using a first technique or a second technique. A method for transmitting the information related to the one or more events has been explained later in conjunction with FIG. 3. In an embodiment, the notification distribution server 104 may be realized through various web-based technologies such as, but not limited to, a Java web framework, a .NET framework, a PHP framework, or any other web application framework. The notification distribution server 104 has been described later in conjunction with FIG. 2.

The one or more sensors 106 may refer to one or more transducer devices that may be installed at remote locations to monitor one or more physical quantities. In an embodiment, the one or more sensors 106 may have suitable circuitry to monitor the one or more physical quantities. For example, the one or more sensors 106 may be configured to determine traffic congestion on a particular route (e.g., sensor 106a). In another example, the one or more sensors 106 may be configured to determine water logging on a route (e.g., sensor 106b).

In an embodiment, the one or more sensors 106 may be coupled to the event generation server 108. The one or more sensors 106 may be configured to transmit the measure of the one or more physical quantities to the event generation server 108. Some examples of the one or more sensors 106 may include, but are not limited to temperature sensors, motion detector sensors, image capturing devices (e.g., CCTV cameras), pressure sensors, displacement sensors, and the like.

The event generation server 108 may refer to a computing device that may include one or more suitable circuitries to perform a predetermined operation. In an embodiment, the event generation server 108 may include one or more processors and one or more memories that comprise computer readable code. In an embodiment, the computer readable code can be executed by the one or more processors to perform the predetermined operation. In an embodiment, the predetermined operation may comprise, but is not limited to, receiving the measure of physical quantities from the one or more sensors 106. The event generation server 108 may further be configured to identify the one or more events from the measure of the one or more physical quantities. In an embodiment, the event generation server 108 may further be configured to store the information pertaining to the one or more events in the database server 110. Further, the event generation server 108 may be configured to determine a rate of detection/identification of the one or more events. In an embodiment, the event generation server 108 may be configured to store the rate of detection/identification of the one or more events in the database server 110. In an embodiment, the event generation server 108 may be realized through various web-based technologies such as, but not limited to, a Java web framework, a .NET framework, a PHP framework, or any other web application framework. In an embodiment, the event generation server 108 has been described later in conjunction with FIG. 2.

A person with ordinary skills in the art will appreciate that the scope of the disclosure is not limited to having the notification distribution server 104 and the event generation server 108 as separate entities. In an embodiment, the functionalities of the notification distribution server 104 and the event generation server 108 may be implemented in a single application server.

The database server 110 may refer to a computing device that may be configured to store the information pertaining to the one or more events. In an embodiment, the database server 110 may further store metadata associated with an event. The metadata may include, but is not limited to, location of occurrence of an event, and time zone/timestamp associated with the occurrence of the event. In an embodiment, the database server 110 may further be configured to store user profiles of the one or more subscribers. In an embodiment, the database server 110 may receive the one or more queries from the subscriber computing device 102, the notification distribution server 104, and the event generation server 108 to retrieve various types of information stored in the database server 110. For querying the database server 110, one or more querying languages may be utilized, such as, but not limited to, SQL, QUEL, DMX, and so forth. Further, the database server 110 may be realized through various technologies such as, but not limited to, Microsoft® SQL Server, Oracle®, IBM DB2®, Microsoft Access®, PostgreSQL®, MySQL® and SQLite®, and the like. In an embodiment, the subscriber computing device 102, the notification distribution server 104, and the event generation server 108 may connect to the database server 110, using one or more protocols such as, but not limited to, ODBC protocol and JDBC protocol.

It will be apparent to a person skilled in the art that the functionalities of the database server 110 may be incorporated into the notification distribution server 104 or the event generation server 108 without departing from the scope of the disclosure. In such a scenario, various types of information, as disclosed above, may be stored in the notification distribution server 104 or the event generation server 108.

The network 112 may correspond to a medium through which information pertaining to the one or more events may be shared among various devices of the system environment 100 (e.g., the subscriber computing device 102, the notification distribution server 104, the one or more sensors 106, the event generation server 108, and the database server 110). Examples of the network 112 may include, but are not limited to, a Wireless Fidelity (Wi-Fi) network, a Wireless Area Network (WAN), a Local Area Network (LAN), or a Metropolitan Area Network (MAN). Various devices in the system environment 100 can connect to the network 112 in accordance with various wired and wireless communication protocols such as Transmission Control Protocol and Internet Protocol (TCP/IP), User Datagram Protocol (UDP), and 2G, 3G, or 4G communication protocols.

FIG. 2 is a block diagram of the event generation server 108, in accordance with at least one embodiment. The event generation server 108 may include a processor 202, a memory 204, a data acquisition (DAQ) unit 206, a transceiver 208, and an event generation unit 210. In an embodiment, the transceiver 208 may be connected to the network 112. In an embodiment, the DAQ unit 206 may be coupled to the one or more sensors 106.

The processor 202 is coupled to the memory 204, the DAQ unit 206, and the transceiver 208. The processor 202 includes suitable logic, circuitry, and/or interfaces that are operable to execute one or more instructions stored in the memory 204 to perform the predetermined operation. The memory 204 may be operable to store the one or more instructions. The processor 202 may be implemented using one or more microprocessor technologies known in the art. Examples of the processor 202 include, but are not limited to, an x86 microprocessor, a RISC microprocessor, an ASIC microprocessor, a CISC microprocessor, or any other microprocessor.

The memory 204 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the memory 204 includes the one or more instructions that are executable by the processor 202 to perform the predetermined operation. It will be apparent to a person with ordinary skill in the art that the one or more instructions stored in the memory 204 may enable the hardware of the system 200 to perform the predetermined operation.

The DAQ unit 206 may comprise suitable logic, circuitry, interfaces, and/or code that may be operable to convert one or more measured physical quantities into one or more digital numeric values that may be processed by a computing device. In an embodiment, the DAQ unit 206 may be coupled to the one or more sensors 106 through one or more communication interfaces such as a Universal Serial Bus (USB) Port, a FireWire Port, an IEEE 1394 standard based connector, and any other serial/parallel data interfacing connector known in the art. In an embodiment, the DAQ unit 206 may perform one or more operations on the one or more measured physical quantities. In an embodiment, the one or more operations may comprise, but are not limited to, conditioning one or more signals received from the one or more sensors 106, and conversion of the one or more conditioned signals to one or more digitals values. In an embodiment, the DAQ unit 206 may further comprise one or more second sensors, one or more signal conditioning circuits, one or more analog-to-digital converters, and one or more digital-to-analog converters.

The transceiver 208 may comprise suitable logic, circuitry, interfaces, and/or code that may be operable to transmit and receive messages and data to/from various components of the system environment 100 (e.g., the subscriber computing device 102, the notification distribution server 104, and the database server 110) over the network 112. In an embodiment, the transceiver 208 may be configured to transmit the information pertaining to the one or more events to the database server 110. Examples of the transceiver 208 may include, but are not limited to, an antenna, an Ethernet port, a USB port, or any other port that can be configured to receive and transmit data. The transceiver 208 transmits and receives data/messages in accordance with the various communication protocols such as TCP/IP, UDP, and 2G, 3G, or 4G communication protocols.

The event generation unit 210 may comprise suitable logic, circuitry, interfaces, and/or code that may be operable to detect the one or more events from the measure of the one or more physical quantities. In an embodiment, the event generation unit 210 may compare the measure of the one or more physical quantities with a predetermined threshold to detect the one or more events. In an embodiment, the event generation unit 210 may be realized through application specific integrated circuits (ASIC) or a field programmable gate array (FPGA).

The operation of the event generation server 108 has been described later in conjunction with FIG. 3.

FIG. 3 is a flowchart 300 that illustrates a method for generating the one or more events, in accordance with at least one embodiment. In an embodiment, the flowchart 300 has been described in conjunction with FIG. 1 and FIG. 2.

At step 302, a signal is received from the one or more sensors 106. In an embodiment, the DAQ unit 206 may be configured to receive the signal. A person with ordinary skills in the art will appreciate that the received signal may correspond to an analog signal from the one or more sensors 106. For example, if a sensor from the one or more sensors 106 corresponds to a temperature sensor, the signal received from the sensor may correspond to a current signal. Similarly, if the sensor corresponds to an image capturing device, the signal may correspond to a video stream.

At step 304, an analog to digital conversion operation is performed on the received signal. In an embodiment, the DAQ unit 206 may be configured to convert the analog signal to a digital signal by utilizing known A/D conversion techniques. Some examples of the known A/D conversion techniques may include, but are not limited to, direction conversion ADC, successive approximation, ramp-compare ADC, and Wilkison ADC. Based on the ADC, the DAQ unit 206 may be configured to determine the measure of the physical quantity.

In a scenario, where the analog signal corresponds to the video stream, the DAQ unit 206 may apply one or more image processing techniques to process the video stream. In an embodiment, the DAQ unit 206 may determine the measure of a physical quantity by applying the one or more image processing techniques on the video stream. For example, based on the one or more image processing techniques, the DAQ unit 206 may be configured to determine traffic congestion captured in the video stream.

At step 306, a check is performed to determine whether the measure of the physical quantity is greater than the predetermined threshold. In an embodiment, the event generation unit 210 may be configured to perform the check. In an embodiment, if at step 306, it is determined that the measure of the physical quantity is less than the predetermined threshold, the event generation unit 210 repeats the steps 302-306. In an embodiment, if at step 306, it is determined that the measure of the physical quantity is greater than the predetermined threshold, the processor 202 may perform step 308.

At step 308, an event is created. In an embodiment, the event generation unit 210 may be configured to create the event related to the measure of the physical quantity that is greater than the predetermined threshold. In an embodiment, the event generation unit 210 may be further configured to append the metadata associated with the event. For example, the event generation unit 210 may append a location of the event. In an embodiment, the event generation unit 210 may determine the location based on the location of the sensor from which the measure of the physical quantity may have been obtained. In another embodiment, the event generation unit 210 may further append information indicative of a type of event as the metadata. In an embodiment, the event generation unit 210 may utilize the following vector to represent the event:

Event={Measure of the physical quantity; Location; Type of Event (1)

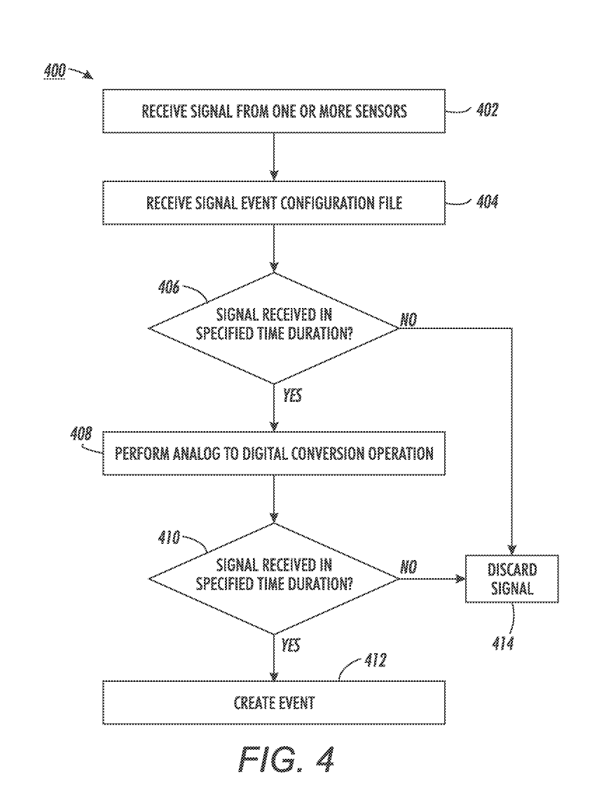

A person with ordinary skills in the art will appreciate that the value of the predetermined threshold may vary based on the physical quantity under consideration. For example, the predetermined threshold for the traffic congestion may be different from the predetermined threshold for the water logging. After detection of the event, the processor 202 may store the information pertaining to the detected event in the database server 110. A person with ordinary skills in the art will appreciate that the scope of the disclosure is not limited to detecting the event from the measure of the physical quantity based on the predetermined threshold. In an embodiment, the processor 202 may consider every measure of the physical quantity received from the one or more sensors 106 as an event, irrespective of whether the measure of the physical quantity is greater than the predetermined threshold. In such a scenario, the processor 202 may receive an event configuration from an administrator based on which the processor 202 may detect and accordingly report the one or more events. In an embodiment, the detection of the one or more events based on the event configuration file has been described in conjunction with FIG. 4.

FIG. 4 is a flowchart 400 illustrating a method for detecting the one or more events based on the event configuration file, in accordance with at least one embodiment. The flowchart 400 has been described in conjunction with FIG. 3.

At step 402, the signal is received from the one or more sensors 106. At step 404, an event configuration file is received. In an embodiment, the processor 202 is configured to receive the event configuration file from the administrator. In an embodiment, the event configuration file may comprise a value of rate of event generation, duration of event generation, and a type of event. In an embodiment, the rate of event generation may correspond to a number of events per hour generated by the event generation server 108. For example, if the rate of event generation is 10, the event generation server 108 may generate 10 events in an hour. In an embodiment, the duration of event generation may correspond to a time interval during which the event generation server 108 generates the one or more events. For example, if the duration of event generation is one hour, between 3:00 PM to 4:00 PM, the event generation server 108 may utilize the signal received in time interval between 3:00 PM to 4:00 PM to generate the one or more events. In an embodiment, the event generation server 108 may ignore the signal received during any other time interval other than the time interval specified in the event configuration file. In an embodiment, the event generation server 108 may generate the one or more events based on the type of the event specified in the event configuration file. For example, if the type of the event corresponds to traffic congestion, the event generation server 108 may generate only traffic congestion-related events.

At step 406, a check is performed to determine whether the signal is received during the time interval specified in the event configuration file. In an embodiment, the processor 202 may be configured to perform the check. In an embodiment, if at step 406, the processor 202 determines that the signal is received at a time instance that is outside the specified time interval, the processor 202 may ignore or discard the signal. Further, if the processor 202 determines, at step 406, that the signal is received during the specified time interval, the processor 202 may consider the received signal for further processing.

At step 408, the analog-to-digital conversion operation is performed on the received signal. In an embodiment, the DAQ unit 206 may perform the analog to digital conversion. In an embodiment, to perform the ADC, the DAQ unit 206 may sample the received signal based on a sampling rate. In an embodiment, the DAQ unit may determine the sampling rate based on the rate of generation of the events. In an embodiment, the sampling rate of the received signal is directly proportional to the rate of generation of the received signal. In an embodiment, the DAQ unit 206 is configured to determine the measure of the physical quantity based on the ADC of the received signal.

At step 410, a check is performed to determine whether the measure of the physical quantity corresponds to the specified type of the event. In an embodiment, the processor 202 may perform the check. In an embodiment, if the processor 202 determines that the measure of the physical quantity corresponds to the specified type of event, the processor 202 may consider the measure of the physical quantity as the generated event and may formulate the event as per equation 1 mentioned supra (depicted by 412). In an embodiment, if at step 410, the processor 202 determines that the measure of the physical quantity does not correspond to the specified type of event, the processor 202 may discard the measure of the physical quantity (depicted by 414).

A person with ordinary skills in the art will appreciate that the scope of the disclosure is not limited to the processor 202 performing the steps 406-410 in the specified order. In an embodiment, the steps 406-410 may be performed in any possible order. Further, the person with ordinary skills in the art will appreciate that the method described in the flowchart 400 may be modified to include the step 306 of the flowchart 300.

After generation of the one or more events, the processor 202 may store the information pertaining to the one or more events in the database server 110. In an embodiment, the processor 202 may transmit the information pertaining to the one or detected events to the notification distribution server 104 as soon as the event generation server 108 receives the one or more events.

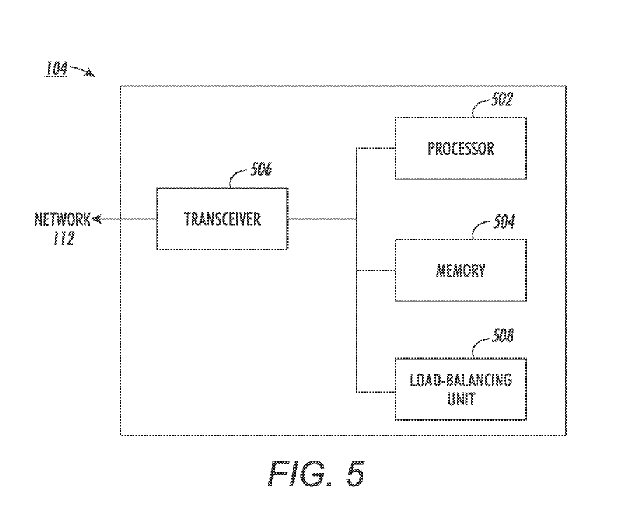

FIG. 5 is a block diagram of the notification distribution server 104, in accordance with at least one embodiment. The notification distribution server 104 includes a processor 502, a memory 504, a transceiver 506, and a load-balancing unit 508. The transceiver 506 is coupled to the network 112.

The processor 502 may include suitable logic, circuitry, and/or interfaces that may be operable to execute one or more instructions stored in the memory 504 to perform predetermined operation. The processor 502 may be coupled to the memory 504, the transceiver 506, and the load-balancing unit 508. The memory 504 may be operable to store the one or more instructions. The processor 502 may be implemented using one or more microprocessor technologies known in the art. Examples of the processor 502 include, but are not limited to, an x86 microprocessor, a RISC microprocessor, an ASIC microprocessor, a CISC microprocessor, or any other microprocessor.

A person skilled in the art will appreciate that the scope of the disclosure should not be limited to the notification distribution server 104 having a single processor. The notification distribution server 104 may include more than one processor, which may operate in parallel and perform the predetermined operation. Further, in an embodiment, the processor 502 may be capable of performing more than one operations in parallel. For example, the processor 502 may be a multi-threaded processor, which may execute more than one threads/processes concurrently. Each such thread/process may be executed to perform the predetermined operation.

The memory 504 stores a set of instructions and data. Some of the commonly known memory implementations include, but are not limited to, a Random Access Memory (RAM), a Read Only Memory (ROM), a Hard Disk Drive (HDD), and a Secure Digital (SD) card. Further, the memory 504 includes the one or more instructions that are executable by the processor 502 to perform specific operations. It will be apparent to a person with ordinary skill in the art that the one or more instructions stored in the memory 504 enables the hardware of the system 500 to perform the predetermined operation.

The transceiver 506 transmits and receives messages and data to/from various components of the system environment 100 (e.g., the subscriber computing device 102, the event generation server 108, and the database server 110) over the network 112. In an embodiment, the transceiver 506 may receive the one or more queries from the subscriber computing device 102. Further, the transceiver 506 may receive the information pertaining to the one or more events from the database server 110. In an embodiment, the transceiver 506 may transmit the information pertaining to the one or more events to the subscriber computing device 102 based at least on the first boundary condition and the second boundary condition. Examples of the transceiver 506 may include, but are not limited to, an antenna, an Ethernet port, a USB port, or any other port that can be configured to receive and transmit data. The transceiver 506 transmits and receives data/messages in accordance with the various communication protocols such as TCP/IP, UDP, and 2G, 3G, or 4G communication protocols.

The load-balancing unit 508 comprises suitable logic, circuitry, interface, and/or code that are configured to perform load-balancing operation on the notification distribution server 104. In an embodiment, the load-balancing unit 508 may be configured to determine a count of events generated by the event generation server 108, and a count of queries/subscription received through the transceiver 506. Based on the count of the one or more events and the count of the queries/subscriptions, the load-balancing unit 508 may determine the first boundary condition and the second boundary condition. The load-balancing unit 508 may instruct the transceiver 506 to transmit the information pertaining to the one or more events based on the first boundary condition and the second boundary condition. In an embodiment, the load-balancing unit 508 may be implemented using one or more known technologies such as ASIC and FPGA.

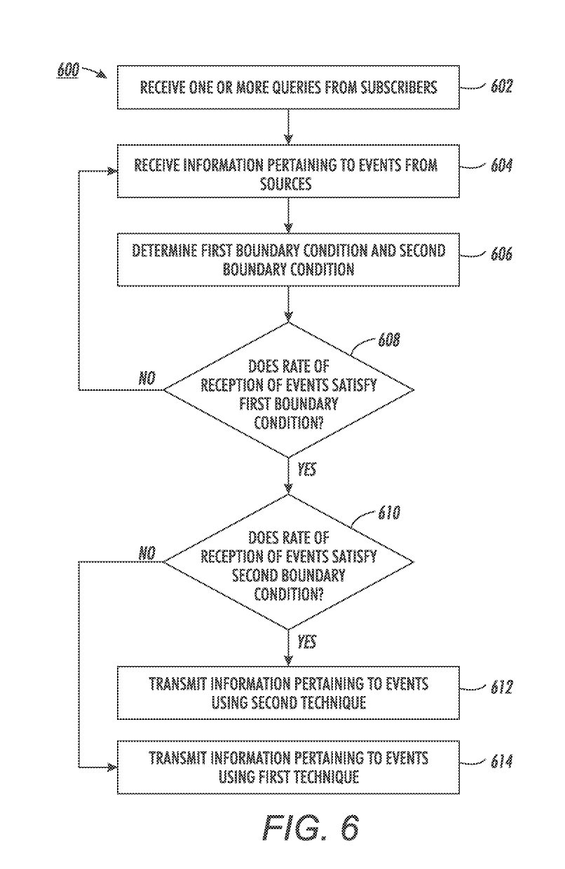

The operation of the notification distribution server 104 has been described later in conjunction with FIG. 6.

FIG. 6 is a flowchart 600 that illustrates a method to transmit the information for the one or more events, in accordance with at least one embodiment. The flowchart 600 is described in conjunction with FIG. 1 and FIG. 2.

At step 602, the one or more queries are received from the subscriber computing device 102. In an embodiment, the processor 502 may receive the one or more queries from the subscriber computing device 102. In an embodiment, the one or more queries may correspond to a subscription for reception of the information pertaining to an event from the one or more events. In another embodiment, the one or more queries may correspond to a one-time request for the information pertaining to the one or more events. In an embodiment, the one or more queries may correspond to data-driven queries that comprise two components such as an operation code (i.e., opcode), and one or more operands. In an embodiment, the opcode may be indicative of the information required by the one or more subscribers. In an embodiment, the operands may correspond to a limitation/restriction on the required information. Some examples of the limitation/restriction may include, but are not limited to, a space region or location information, a time duration, or one or more event keywords. In an embodiment, each query may have a single opcode and multiple operands. Following is an example representation of a query:

<Opcode><Operand 1> . . . <Operand N> (2)

In an embodiment, the processor 502 may be receive the one or more queries as a phrase. In an embodiment, the processor 502 may be configured to apply natural language processing techniques to extract or determine opcode and the one or more operands from the phrase. For instance, the processor 502 receives a phrase “what is the traffic situation on NH8”. The processor 502 may apply the natural language processing techniques to determine that the information required by the subscriber or requestor is traffic information, and therefore, the traffic information corresponds to the opcode of the query. Further, based on the natural language processing techniques, the processor 502 determines that the requestor may want to know the traffic situation on NH-8. Therefore, the processor 502 may consider “NH-8” as the operand.

In an alternate embodiment, the processor 502 may receive the one or more queries from the subscriber through a user interface displayed to the subscriber. In an embodiment, the user interface may include input text boxes that allows the user to provide the type of information required and the location or duration of the information required.

In an embodiment, the one or more queries may be classified as primitive queries, abstract queries, and subscription requests for the information pertaining to the one or more events. In an embodiment, the primitive queries may further be classified as event queries, spatial queries, and temporal queries.

### Event Query

In an embodiment, the processor 502 may identify a received query as an event query based at least on one or more event keywords. In an embodiment, the one or more event keywords may include one or more of, but are not limited to, a location of an event, a name of the event, and so on. In an embodiment, the event query may correspond to a query that may extract the event information for a space region and a time region. For example, an event query may correspond to “Get all events in [area] from [datetime1] to [datetime2]”. The processor 502 may further identify the opcodes and the operands in the query. The opcodes are “area”, “datetime1”, and “datetime2”. On the other hand, the operand is “Get all events”. In another example, the event query such as “[k] most/least occurrences of events in area from datetime1 to datetime2”. Similarly, the processor 502 may identify the opcodes and the operands in the query. The opcodes are “area”, “datetime1”, and “datetime2”. On the other hand, the operand is “[k] most/least occurrences of events”.

### Spatial Queries

In an embodiment, the processor 502 may receive the spatial queries from the one or more subscribers in order to determine a set of locations/areas for the one or more event keywords (as discussed above), and the time region. In an embodiment, the spatial queries may be utilized to retrieve the set of locations/areas for the one or more event keywords (as discussed above), and the time region. For example, for a spatial query, such as “Area with Max/Min problems from time1 to time2 having [keywords]”, the processor 502 may further determine the operand and the opcode. The opcodes are “time1”, “time2”, and “[keywords]”. On the other hand, the operand is “Area with Max/Min problems from time1 to time2 having keywords”.

### Temporal Queries

In an embodiment, the processor 502 may receive the temporal queries from the one or more subscribers to determine the time for specified location and the one or more event keywords. In an embodiment, the processor 502 may utilize the temporal queries to determine an optimum time to carry out a specific task in a particular area. For example, if a subscriber is plans to travel, then the subscriber would not want to get stuck in a traffic jam. In such cases, the subscriber may want to know an optimum time to make the journey, and even which day of the week would be a better option. Such type of queries fall under the temporal queries. For example, the query such as “Most/Least problem timings and durations within a time window in area for events having [keywords]”, the query consists of an opcode such as “area”, and “[keywords]”. On the other hand, the operand is “most/least problem timings and durations within a time window”.

### Abstract Queries

In an embodiment, the one or more queries may correspond to the abstract queries that may be an aggregation of queries received from one or more organizations (e.g., city agencies, etc.). Further, the processor 502 may consider such abstract queries as the primitive queries. For example, an abstract query such as “route suggestion from location 1 to location 2 having no problems of traffic”, the abstract query consists of opcodes “Route suggestion” and operands “location 1”, and “location 2”, and “traffic”.

In an embodiment, the processor 502 may be configured to keep a track of the number of the one or more queries received from the one or more subscribers. In an embodiment, the processor 502 may further monitor a rate of reception of the one or more queries. In an embodiment, the processor 502 may be configured to store the count of the one or more queries and the rate of reception of the one or more queries in the database server 110.

A person with ordinary skill in the art will understand that the scope of the disclosure is not limited to the aforementioned queries only. In an embodiment, the processor 502 may receive queries that are different from the one or more queries mentioned above, without departing from the scope of the disclosure.

At step 604, the information pertaining to the one or more events is retrieved from the database server 110. In an embodiment, the processor 502 may retrieve the information pertaining to the one or more events. In an embodiment, the processor 502 may further be configured to retrieve information pertaining to a rate of reception of the one or more events, a duration in which the one or more events is generated, and a type of the one or more events. As described supra in conjunction with FIG. 3 and FIG. 4, the one or more events are generated by the event generation server 108 based on the event configuration file. In an alternate embodiment, the one or more events are generated based on the predetermined threshold value.

In an alternate embodiment, the information pertaining to the one or more events are received directly from the event generation server 108, as soon as the event is generated by the event generation server 108. In such a scenario, the rate of reception of the events, a duration in which the one or more events is generated, and the type of the one or more events, are determined by the processor 502.

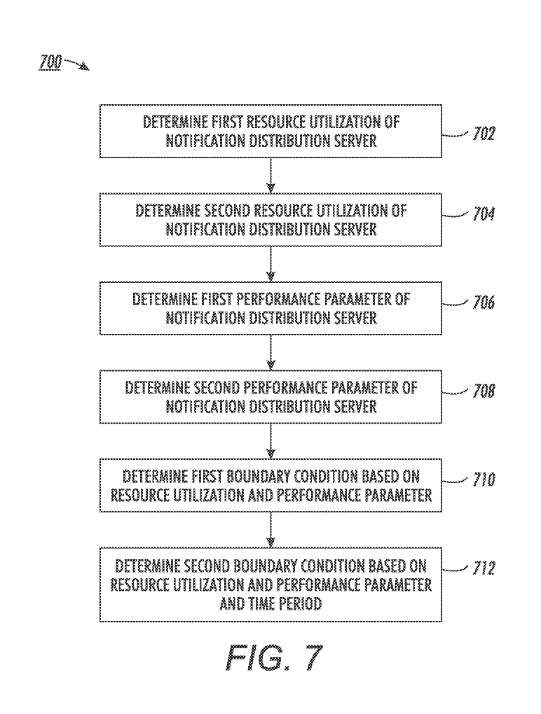

At step 606, the first boundary condition and the second boundary condition are determined. In an embodiment, the load-balancing unit 508 is configured to determine the first boundary condition and the second boundary condition based on the rate of reception of the one or more events and the count of the one or more queries. In an embodiment, the determination of the first boundary condition and the second boundary condition has been described later in conjunction with FIG. 7.

At step 608, a check is performed to determine whether the rate of reception of the one or more events and the number of subscribers (or the count of the one or more queries received) satisfy the first boundary condition. In an embodiment, the load-balancing unit 508 may be configured to perform the check. If the rate of reception of the one or more events and the number of subscribers (or the count of the one or more queries received) satisfy the first boundary condition, then the load-balancing unit 508 performs the step 610, else the step 604 is performed.

At step 610, another check is performed to determine whether the rate of reception of the one or more events and the number of subscribers (or the count of the one or more queries received) satisfy the second boundary condition. In an embodiment, the load-balancing unit 508 may perform the check. If the rate of reception of the one or more events and the number of subscribers (or the count of the one or more queries received) satisfy the second boundary condition, then the load-balancing unit 508 may execute step 612, else step 614 is executed.

At step 612, the information pertaining to the one or more events is transmitted using the second technique. In an embodiment, if the rate of reception of the one or more events and the number of subscribers (or the count of the one or more queries received) satisfy the first boundary condition and the second boundary condition, the load-balancing unit 508 may instruct the transceiver 506 to transmit the information pertaining to the one or more events to the one or more subscriber-computing devices 102 using the second technique. In an embodiment, the second technique may correspond to a time-triggered notification technique. In an embodiment, the time-triggered notification technique may correspond to a technique of transmitting the information pertaining to the one or more events to the one or more subscribers after a pre-defined time period may have elapsed. In an embodiment, when the pre-defined time period has not elapsed, the load-balancing unit 508 may be configured to store all the received information pertaining to the one or more events in a buffer. Thereafter, after the predefined time period elapses, the load-balancing unit 508 may be configured to instruct the transceiver 506 to transmit the one or more information stored in the buffer.

For instance, let the predefined time duration be one hour, and the time instance when the predefined time duration elapses be 1:00 PM. If an event arrives at a time 12:30 P.M., then the load-balancing unit 508 may not transmit the information pertaining to the one or more events. In an embodiment, the load-balancing unit 508 may store the received event in the buffer (for example, the memory 504). Thereafter, the load-balancing unit 508 may transmit the information pertaining to the one or more events to the one or more subscriber-computing devices 102 at 1:00 PM (i.e., when the predefined time period may have elapsed).

At step 614, the information pertaining to the one or more events is transmitted using the first technique. In an embodiment, the load-balancing unit 508 is configured to instruct the transceiver 506 to transmit the information pertaining to the one or more events using the first technique. If the rate of reception of the one or more events and the number of subscribers (or the count of the one or more queries received) satisfy the first boundary condition but does not satisfy the second boundary condition, the load-balancing unit 508 may instruct the transceiver 506 to transmit the information pertaining to the one or more events to the one or more subscriber computing device 102 using the first technique. In an embodiment, the first technique may correspond to an event-triggered notification technique. The event-triggered notification technique may correspond to a technique of transmitting the information pertaining to the one or more events as soon as the one or more events are generated by the event generation server 108. In an embodiment, the transmission of the information to the one or more subscriber-computing devices 102 is in real time or near real time.

For example, as discussed above, if an event is generated at a time 12:30 P.M., then the load-balancing unit 508 may instruct the transceiver 506 to transmit the information pertaining to the one or more events to the one or more subscribers based on an arrival of the event.

FIG. 7 is a flowchart 700 that illustrates a method to determine the first boundary condition and the second boundary condition, in accordance with at least one embodiment. The flowchart 700 is described in conjunction with FIG. 1, FIG. 2, FIG. 3, FIG. 4, FIG. 5, and FIG. 6.

At step 702, a first resource utilization of the notification distribution server 104 for the first transmission technique is determined. In an embodiment, the processor 502 may be configured to determine the first resource utilization of the notification distribution server 104 based at least on the rate of reception of the one or more events, a number of subscriptions to receive the information pertaining to the one or more events, and the count of the one or more queries. In an embodiment, the processor 502 may determine the first resource utilization for each event type. In an embodiment, the first resource utilization may correspond to a percentage utilization of one or more resource types of the notification distribution server 104, when the notification distribution server 104 transmits the information using the first technique. In an embodiment, the one or more resource types may include, but are not limited to a CPU, a memory, a network, or an input/output device.

In an embodiment, the processor 502 may utilize one or more known benchmarking techniques to determine the first resource utilization of the notification distribution server 104. In an embodiment, the processor 502 may simulate a reception of the one or more events of a particular type. In an embodiment, the processor 502 may further vary the rate of reception of the one or more events. In an embodiment, the processor 502 may instruct the load-balancing unit 508 to transmit the notifications/information pertaining to the one or more events using the first technique, during the benchmarking process. In an embodiment, the processor 502 may determine the utilization each of the one or more resource types in the notification distribution server 104. Further, the processor 502 may monitor the delay in the reception of the one or more events and the transmission of the information pertaining to the one or more events. In an embodiment, the processor 502 may utilize the following equation to determine the first resource utilization:

Utilization of resource type i for event type eₜ=Uᵢₜ(rₜ,sₜ|(rₜ_{_{MIN}}≦rₜ≦rₜ_{_{MAX}}) [symbol] (sₜ_{_{MIN}}≦sₜ≦sₜ_{_{MAX}})) (3)

where,

Uᵢₜ(rᵣ,sₜ)=Resource Utilization of resource type I;

rₜ=Rate of arrival of the one or more events;

sₜ=Number of subscriptions by the one or more subscribers of the one or more events;

r_{tMIN}=Minimum rate of arrival of the one or more events (determined based on the benchmarking techniques);

r_{tMAX}=Maximum rate of arrival of the one or more events (determined based on the benchmarking techniques);

s_{tMIN}=Minimum of subscribers of event type t (determined based on the benchmarking techniques); and

s_{tMAX}=Maximum of subscribers of event type t (determined based on the benchmarking techniques).

At step 704, a second resource utilization of the notification distribution server 104 for the second transmission technique is determined. In an embodiment, the processor 502 may be configured to determine the second resource utilization of the notification distribution server 104 based at least on the rate of reception of the one or more events, the number of subscriptions to receive the information pertaining to the one or more events, and the count of the one or more queries, and the predefined time duration. As discussed above, the predefined time duration corresponds to the time durations after which the information pertaining to the one or more events is transmitted to the one or more subscriber-computing devices 102.

In an embodiment, the processor 502 may determine the second resource utilization for each event type. In an embodiment, the second resource utilization may correspond to a percentage utilization of one or more resource types of the notification distribution server 104, when the notification distribution server 104 transmits the information using the second technique.

In an embodiment, the processor 502 may utilize one or more known benchmarking techniques to determine the second resource utilization of the notification distribution server 104. In an embodiment, the processor 502 may simulate a reception of the one or more events of a particular type. In an embodiment, the processor 502 may further vary the rate of reception of the one or more events. In an embodiment, the processor 502 may instruct the load-balancing unit 508 to transmit the notifications/information pertaining to the one or more events using the second technique, during the benchmarking process. Further, the processor 502 may vary the predefined time duration. In an embodiment, the processor 502 may determine the utilization each of the one or more resource types in the notification distribution server 104, when the notification distribution server 104 transmits the information pertaining to the one or more event using the second technique. Further, the processor 502 may monitor the delay in the reception of the one or more events and the transmission of the information pertaining to the one or more events. In an embodiment, the processor 502 may utilize the following equation to determine the second resource utilization:

Utilization of resource type i for event type eₜ=Uᵢₜ(rₜ,sₜ,δₜ|(rₜ_{_{MIN}}≦rₜ≦rₜ_{_{MAX}}) [symbol] (sₜ_{_{MIN}}≦sₜ≦sₜ_{_{MAX}}) [symbol] (0≦δₜ≦δₜ_{_{MAX}})) (4)

where,

Uᵢₜ(rₜ,sₜ, δₜ=Second resource utilization, and

δₜ=Predefined Time duration.

At step 706, a first performance parameter of a notification distribution server 104 is determined. In an embodiment, the processor 502 determines the first performance parameter of the notification distribution server 104 based on the based at least on the rate of reception of the one or more events, the number of subscriptions of the one or more events, and a the count of the one or more queries. In an embodiment, the first performance parameter may correspond to at least a percentage of successful transmission of the information pertaining to the one or more events, or a delay in sending the information pertaining to the one or more events from the rate of reception of the one or more events to the notification distribution server 104. In an embodiment, the first performance parameter is determined, when the notification distribution server 104 transmits the information using the first technique. In an embodiment, the processor 502 utilize the following equation to determine the first performance parameter:

Value of Performance Parameter j for event type e_t=pⱼ(rₜ,sₜ|(rₜ_{_{MIN}}≦rₜ≦rₜ_{_{MAX}}) [symbol] (sₜ_{_{MIN}}≦sₜ≦sₜ_{_{MAX}})) (5)

where,

pⱼ(rₜ,sₜ). First Performance Parameter for the first boundary condition,

rₜ=Rate of arrival of the one or more events, and

sₜ=Number of subscriptions by the one or more subscribers of the one or more events.

At step 708, a second performance parameter of a notification distribution server 104 is determined. In an embodiment, the processor 502 determines the second performance parameter of the notification distribution server 104 the based at least on the rate of reception of the one or more events, the number of subscriptions of the one or more events, a the count of the one or more queries, and the predefined time duration. In an embodiment, the second performance parameter may correspond to at least a percentage of successful transmission of the information pertaining to the one or more events, or a delay in sending the information pertaining to the one or more events from the rate of reception of the one or more events to the notification distribution server 104. In an embodiment, the second performance parameter is determined, when the notification distribution server 104 transmits the information using the second technique. In an embodiment, the processor 502 utilize the following equation to determine the second performance parameter:

Value of Performance Parameter j for event type e_t=qⱼ(rₜ,sₜ,δₜ|(rₜ_{_{MIN}}≦rₜ≦rₜ_{_{MAX}}) [symbol] (sₜ_{_{MIN}}≦sₜ≦sₜ_{_{MAX}}) [symbol] (0≦δₜ≦ₜ_{_{MAX}})) (6)

where,

qⱼ(rₜ, sₜ, δₜ=Performance parameter for the second boundary condition,

rₜ=Rate of arrival of the one or more events,

sₜ=Number of subscriptions by the one or more subscribers of the one or more events, and

δₜ=Time period.

At step 710, the first boundary condition is determined. In an embodiment, the processor 502 may determine the first boundary condition based at least on the first resource utilization and the first performance parameter of the notification distribution server 104. In an embodiment, the processor 502 may utilize the following equation to determine the first boundary condition:

$$( {ξ}_{t} , {ψ}_{t} ) = \{ \begin{matrix}min \\ {r}_{{t}_{MI N}} \leq {r}_{t} \leq {r}_{{t}_{MA X}}\end{matrix} ( {r}_{t} ) , {min}_{{s}_{{t}_{MI N}} \leq {s}_{t} \leq {s}_{{t}_{M AX}}} ( {s}_{t} ) \vert ( {V}_{i ∈ R} ( {U}_{it} ( {r}_{t} , {s}_{t} ) = {Thres}_{i} ) {V}_{j ∈ P} ( {p}_{j} ( {r}_{t} , {s}_{t} ) = {ThresPerf}_{j} ) \} \qquad ( 7 )$$

where,

ξₜψₜ=Values of First Boundary condition,

Thresᵢ=Maximum threshold utilization of resource type i, and

ThresPerfⱼ=Minimum threshold value of performance parameter j.

At step 712, the second boundary condition is determined. In an embodiment, the processor 502 may determine the second boundary condition based at least on the second resource utilization and the second performance parameter of the notification distribution server 104. In an embodiment, the processor 502 may utilize the following equation to determine the second boundary condition:

$$( hl {ξ}_{t} , hl {ψ}_{t} ) = \{ \begin{matrix}min \\ {r}_{{t}_{MI N}} \leq {r}_{t} \leq {r}_{{t}_{MA X}}\end{matrix} ( {r}_{t} ) , {min}_{{s}_{{t}_{MI N}} \leq {s}_{t} \leq {s}_{{t}_{M AX}}} ( {s}_{t} ) \vert ( {V}_{i ∈ R} ( {U}_{i} ( {r}_{t} , {s}_{t} ) = {Thres}_{i} ) {V}_{j ∈ P} ( {q}_{j} ( {r}_{t} , {s}_{t} ) = {ThresPerf}_{j} ) \} \qquad ( 8 )$$

where,

hlξₜ, hlψₜ=Values of Second Boundary condition,

Thresᵢ=Maximum threshold utilization of resource type, i, and

ThresPerfⱼ=Minimum threshold value of performance parameter, j.

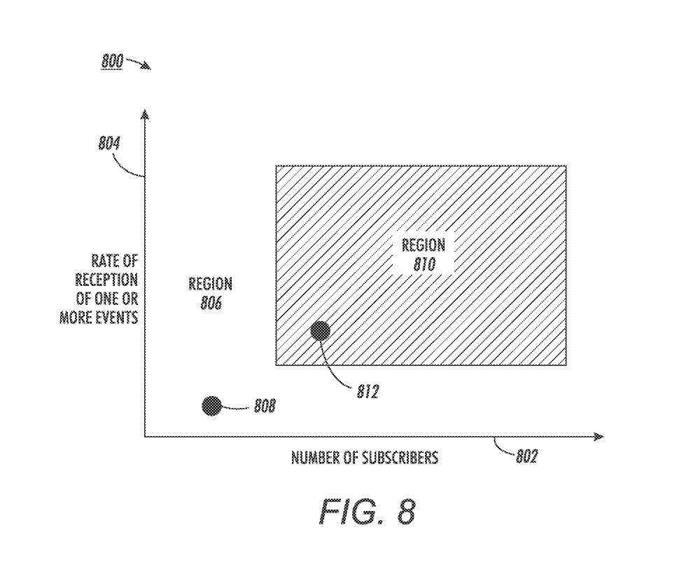

In an embodiment, an exemplary visualization of the first boundary condition and the second boundary condition has been illustrated in conjunction with FIG. 8.

FIG. 8 is a graphical representation 800 that illustrates the first boundary condition and the second boundary condition, in accordance with at least one embodiment. In an embodiment, the graphical representation 800 has been described in conjunction with FIG. 7.

The graphical representation 800 comprises an x-axis 802 and a y-axis 804. The x-axis 802 represents the number of subscriptions and the count of the one or more queries received. The y-axis 804 represents the rate of arrival of the one or more events. In an embodiment, a region 806 in the graphical representation 800 represents the first boundary condition. If the count of the one or more subscribers and the rate of receipt of the one or more events lie in the region 806, the load-balancing unit 508 may transmit the notifications using the first technique. For example, if the rate of receipt of the one or more events is 10 events per hour and the number of subscribers is 10 (represented by the coordinate 808), the load-balancing unit 508 may utilize the first technique.

Similarly, in an embodiment, a region 810 in the graphical representation 800 represents the second boundary condition. If the count of the one or more subscribers and the rate of receipt of the one or more events lie in the region 810, the load-balancing unit 508 may transmit the notifications using the second technique. For example, if the rate of receipt of the one or more events is 30 events per hour and the number of subscribers is 70 (represented by the coordinate 812), the load-balancing unit 508 may utilize the second technique.

The disclosed embodiments encompass several advantages. Various embodiments of the disclosure lead to a method and a system for transmitting information generated for one or more events. Through various embodiments of the disclosure, one or more queries are received from one or more subscribers. Further, it is disclosed that the information pertaining to the one or more events are received from one or more sensors 106. Further, it is disclosed that a first boundary condition is determined based at least on a resource utilization and a performance parameter. Further, it is disclosed that a second boundary condition is determined based at least on the resource utilization, the performance parameter, and a time period associated with the distribution of the information pertaining to the one or more events. Further, it is disclosed that a number of events in the one or more events satisfy the first boundary condition and the second boundary condition is determined. Thereafter, based on the determination, it is disclosed that the information pertaining to the one or more events may be transmitted to the one or more subscribers either by an event-triggered notification technique, or a time-triggered notification technique. This method enables an automatic transfer of the information pertaining to the one or more events to the one or more subscribers without any delay. Further, the method discloses the good customer experience. This method of transmitting the information generated for the one or more events is more robust. Further, the method is capable of transmitting information generated for events that may be available in a massive scale without limiting the scope of the disclosure.

The disclosed methods and systems, as illustrated in the ongoing description or any of its components, may be embodied in the form of a computer system. Typical examples of a computer system include a general-purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit and the Internet. The computer further comprises a microprocessor. The microprocessor is connected to a communication bus. The computer also includes a memory. The memory may be Random Access Memory (RAM) or Read Only Memory (ROM). The computer system further comprises a storage device, which may be a hard-disk drive or a removable storage drive, such as, a floppy-disk drive, optical-disk drive, and the like. The storage device may also be a means for loading computer programs or other instructions into the computer system. The computer system also includes a communication unit. The communication unit allows the computer to connect to other databases and the Internet through an input/output (I/O) interface, allowing the transfer as well as reception of data from other sources. The communication unit may include a modem, an Ethernet card, or other similar devices, which enable the computer system to connect to databases and networks, such as, LAN, MAN, WAN, and the Internet. The computer system facilitates input from a user through input devices accessible to the system through an I/O interface.

In order to process input data, the computer system executes a set of instructions that are stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks, such as steps that constitute the method of the disclosure. The systems and methods described can also be implemented using only software programming or using only hardware or by a varying combination of the two techniques. The disclosure is independent of the programming language and the operating system used in the computers. The instructions for the disclosure can be written in all programming languages including, but not limited to, ‘C’, ‘C++’, ‘Visual C++’ and ‘Visual Basic’. Further, the software may be in the form of a collection of separate programs, a program module containing a larger program or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms including, but not limited to, ‘Unix’, DOS′, ‘Android’, ‘Symbian’, and ‘Linux’.

The programmable instructions can be stored and transmitted on a computer-readable medium. The disclosure can also be embodied in a computer program product comprising a computer-readable medium, or with any product capable of implementing the above methods and systems, or the numerous possible variations thereof.

Various embodiments of the methods and systems for transmitting information generated for one or more events have been disclosed. However, it should be apparent to those skilled in the art that modifications in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, or utilized, or combined with other elements, components, or steps that are not expressly referenced.

A person with ordinary skills in the art will appreciate that the system, modules, and sub-modules have been illustrated and explained to serve as examples and should not be considered limiting in any manner. It will be further appreciated that the variants of the above disclosed system elements, or modules and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules and is not limited to any particular computer hardware, software, middleware, firmware, microcode, or the like.

The claims can encompass embodiments for hardware, software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art, which are also intended to be encompassed by the following claims.

What is claimed is:

1. A method for transmitting information generated for one or more events, said method comprising:
in a notification distribution server:
receiving, by a transceiver, one or more queries from one or more subscribers;
receiving, by said transceiver, said information pertaining to said one or more events from one or more sensors; and
transmitting, by one or more microprocessors, said information pertaining to said one or more events to said one or more subscribers based on a first boundary condition and a second boundary condition,
wherein said information pertaining to said one or more events is transmitted using a first technique when at least a number of events in said one or more events satisfy said first boundary condition, and
wherein said information pertaining to said one or more events is transmitted using a second technique when at least said number of events in said one or more events satisfy said second boundary condition.

2. The method of claim 1 further comprising determining, by said one or more microprocessors, a first resource utilization of said notification distribution server, a first performance parameter of said notification distribution server based at least on a rate of reception of said information pertaining to said one or more events, and a number of subscriptions by said one or more subscribers of said one or more events.

3. The method of claim 2 further comprising determining, by said one or more microprocessors, said first boundary condition based at least on said first resource utilization, and said first performance parameter.

4. The method of claim 2, wherein said first resource utilization corresponds to a percentage utilization of one or more resource types in said notification distribution server, when the said information pertaining to the one or more events is transmitted using the first technique, wherein said one or more resource types comprise at least one of a CPU, a memory, a network, or an input/output device.

5. The method of claim 2, wherein said first performance parameter comprises at least one of a percentage of successful information pertaining to said one or more events, or a delay in sending said information pertaining to said one or more events from said rate of reception of said one or more events to said notification distribution server.

6. The method of claim 2, wherein a second resource utilization, and a second performance parameter of said notification distribution server, based at least on a rate of reception of said information pertaining to said one or more events, a number of subscriptions by said one or more subscribers of said one or more events, and a time period associated with a distribution of said information pertaining to said one or more events to said one or more subscribers.

7. The method of claim 6 further comprising determining, by said one or more microprocessors, said second boundary condition based at least on said second resource utilization, said second performance parameter, and said time period.

8. The method of claim 6, wherein each of said resource utilization and said performance parameter are determined based on one or more benchmarking techniques.

9. The method of claim 1, wherein said first technique corresponds to an event-triggered notification technique, wherein said event-triggered notification technique comprises transmitting said information to said one or more subscribers in response to reception of said information pertaining to said one or more events from said one or more sensors.

10. The method of claim 1, wherein said second technique corresponds to a time-triggered notification technique, wherein said time-triggered notification technique comprises transmitting said information to said one or more subscribers after a pre-defined time period has elapsed.

11. The method of claim 1, wherein said one or more sensors are utilizable to generate said information pertaining to said one or more events based on a detection of said one or more events.

12. The method of claim 1, wherein said one or more events correspond to events that are anomaly detected by said one or more sensors at a remote location.

13. The method of claim 1, wherein said one or more queries comprise at least one of subscriptions for said information pertaining to said one or more events.

14. The method of claim 13, wherein said one or more queries comprise at least one of primitive queries, abstract queries, and subscription requests for said information pertaining to said one or more events.

15. The method of claim 14, wherein said primitive queries comprise at least one of an event query, spatial queries, and temporal queries.

16. The method of claim 15, wherein said event query corresponds to a query having an event information for a space region, and a time region, wherein said spatial queries correspond to a query having a set of locations/areas for said information pertaining to said one or more events, and said time region, and wherein said temporal queries correspond to a query having a time for said space region and said information generated for said one or more events.

17. The method of claim 1, wherein said information pertaining to said one or more events comprises at least one of a rate of triggering of said one or more events, a duration for which said one or more events is generated, and a type of said one or more events.

18. A system for transmitting information generated for one or more events, said system comprising:
in a notification distribution server:
a transceiver operable to:
receive one or more queries from one or more subscribers;
receive information pertaining to said one or more events from one or more sensors; and
one or more microprocessors operable to:
transmit said information pertaining to said one or more events to said one or more subscribers based on a first boundary condition and a second boundary condition,
wherein said information pertaining to said one or more events is transmitted using a first technique when at least a number of events in said one or more events satisfy said first boundary condition, and
wherein said information pertaining to said one or more events is transmitted using a second technique when at least said number of events in said one or more events satisfy said second boundary condition.

19. The system of claim 18, wherein said one or more microprocessors are further operable to determine a first resource utilization of said notification distribution server, and a first performance parameter of said notification distribution server based at least on a rate of reception of said information pertaining to said one or more events, and a number of subscriptions by said one or more subscribers of said one or more events.

20. The system of claim 19, wherein said one or more microprocessors are further operable to determine said first boundary condition based at least on said first resource utilization, and said first performance parameter.

21. The system of claim 18, wherein said one or more microprocessors are further operable to determine a second resource utilization of said notification distribution server, and a second performance parameter of said notification distribution server, based at least on a rate of reception of said information pertaining to said one or more events, a number of subscriptions by said one or more subscribers of said one or more events, and a time period associated with a distribution of said information pertaining to said one or more events to said one or more subscribers.

22. The system of claim 21, wherein said one or more microprocessors are further operable to determine said second boundary condition based at least on said second resource utilization, said second performance parameter, and said time period.

23. The system of claim 18, wherein said information pertaining to said one or more events comprises at least one of a rate of triggering of said one or more events, a duration for which said one or more events is generated, and a type of said one or more events.

24. A computer program product for use with a computer, the computer program product comprising a non-transitory computer readable medium, wherein the non-transitory computer readable medium stores a computer program code for transmitting information generated for one or more events, wherein the computer program code is executable by one or more microprocessors to:
receive one or more queries from one or more subscribers;
receive said information pertaining to said one or more events from one or more sensors; and
transmit said information pertaining to said one or more events to said one or more subscribers based on a first boundary condition and a second boundary condition,
wherein said information pertaining to said one or more events is transmitted using a first technique when at least a number of events in said one or more events satisfy said first boundary condition, and
wherein said information pertaining to said one or more events is transmitted using a second technique when at least said number of events in said one or more events satisfy said second boundary condition.
